(19) United States
(12) Patent Application Publication
(10) Pub. No.: US 2015/0338797 A1
(43) Pub. Date: Nov. 26, 2015

(54) IMAGE FORMING APPARATUS AND TEMPERATURE CONTROL METHOD FOR FIXING DEVICE IN IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Hirotaka Matsumoto, Yokohama-shi (JP)

(73) Assignees: KABUSHIKI KAISHA TOSHIBA, Tokyo (JP); TOSHIBA TEC KABUSHIKI KAISHA, Tokyo (JP)

(21) Appl. No.: 14/285,703

(22) Filed: May 23, 2014

(51) Int. Cl. G03G 15/20

(52) U.S. Cl. CPC G03G 15/2039

(57) ABSTRACT

According to one embodiment, an image forming apparatus includes a heating member configured to heat a medium, a pressurizing member configured to convey the medium, a main heating source configured to switch and heat a first area and a second area of the heating member, an auxiliary heating source configured to simultaneously heat the first area and the second area, detecting members configured to respectively detect surface temperatures of the first area and the second area, an auxiliary-heating-condition storing section configured to store a energizing time and a non-energizing time of the auxiliary heating source at a start of image formation, and heating-source control sections configured to respectively control the heating in the main heating source and the heating in the auxiliary heating source. The heating-source control sections acquire the energizing time from the auxiliary-heating-condition storing section and control the heating in the auxiliary heating source.

### FIELD

Embodiments described herein relate generally to an image forming apparatus and a temperature control method for a fixing device in the image forming apparatus.

### BACKGROUND

As a device mounted on an image forming apparatus that uses an electrophotographic process such as a copying machine, a facsimile, or a printer, there is a fixing device that fixes a toner image on a sheet by heating and pressurizing the toner image. The fixing device inserts the sheet through a nip formed between a heat roller and a press roller and heats and pressurizes the toner image to fix the toner image on the sheet.

In recent years, energy saving is demanded for the image forming apparatus. In the image forming apparatus, power consumption in the fixing device is large. A reduction in the power consumption in the fixing device greatly affects energy saving of the entire apparatus.

In general, in the fixing device, a temperature change of the heat roller is large during a print operation. An image failure sometimes occurs because of a temperature drop. In particular, a temperature drop during paper feeding to between the rollers is larger in a sheet of a larger size such as the A3 size. Therefore, in the related art, an auxiliary heating source is often mounted separately from a main heating source to reduce a temperature drop of the heat roller and control the temperature of the heat roller to temperature at which an image failure does not occur. However, in the related art, the auxiliary heating source is uniformly lit irrespective of the sheet size. Therefore, power consumption increases even if occurrence of an image failure can be prevented.

### BRIEF DESCRIPTION OF THE DRAWINGS

FIG. 1 is a schematic configuration diagram showing an MFP, which is an image forming apparatus in a first embodiment;

FIG. 2 is a sectional view for explaining the schematic configuration of a fixing device in the first embodiment;

FIG. 3 is a diagram of the fixing device in the first embodiment viewed from a sheet conveying direction;

FIG. 4 is a block diagram showing a control system of the MFP in the first embodiment;

FIG. 5 is a diagram showing an example of auxiliary heating conditions in the first embodiment;

FIG. 6 is a flowchart for explaining a specific example of heating control in the fixing device in the first embodiment;

FIGS. 7A and 7B are diagrams showing a relation among a print operation time, a temperature change of a heat roller, and switching timings of ON and OFF of halogen lamps in the first embodiment;

FIG. 8 is a diagram for comparing and explaining power consumptions of a fixing device of a conventional model and the fixing device in the first embodiment;

FIG. 9 is a diagram showing an example of auxiliary heating conditions in a second embodiment; and

FIG. 10 is a flowchart for explaining a specific example of heating control in a fixing device in the second embodiment.

### DETAILED DESCRIPTION

In general, according to one embodiment, an image forming apparatus includes: a heating member configured to heat a medium carrying a toner image; a pressurizing member arranged to be opposed to the heating member and configured to convey the medium while holding the medium in conjunction with the heating member; a main heating source provided on the inside of the heating member and configured to switch and heat a first area and a second area of the heating member; an auxiliary heating source provided on the inside of the heating member and configured to simultaneously heat the first area and the second area; detecting members configured to respectively detect surface temperatures of the first area and the second area; an auxiliary-heating-condition storing section configured to store an energizing time and a non-energizing time of the auxiliary heating source at a start of image formation; and heating-source control sections configured to respectively control the heating in the main heating source and the heating in the auxiliary heating source. The heating-source control sections acquire the energizing time from the auxiliary-heating-condition storing section and control the heating in the auxiliary heating source.

### First Embodiment

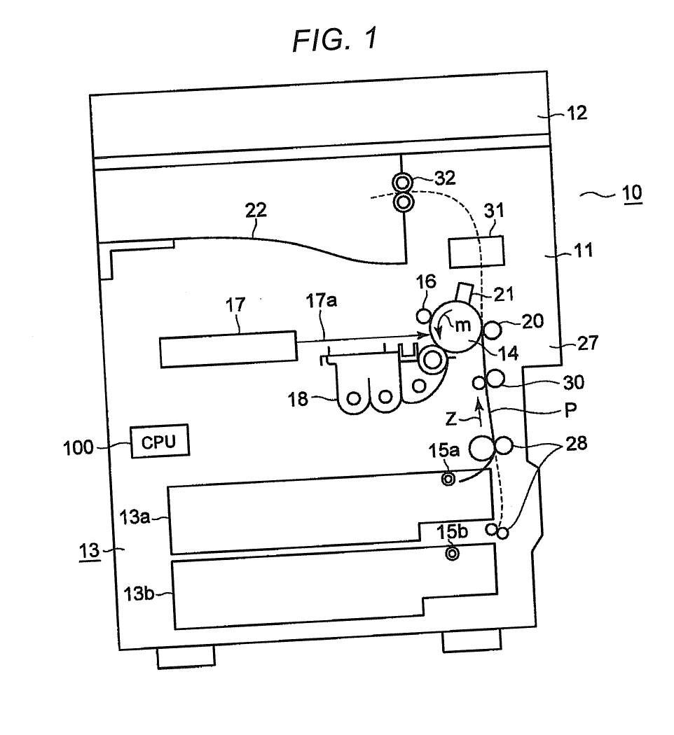

FIG. 1 is a schematic configuration diagram showing an MFP (Multi Function Peripheral) 10, which is an image forming apparatus in a first embodiment. The MFP 10 includes a printer section 11, which is an image forming section, a scanner section 12, a paper feeding section 13, and a paper discharging section 22. The MFP 10 includes a CPU 100, which is a control section configured to control the entire MFP 10.

The paper feeding section 13 includes first and second paper feeding cassettes 13a and 13b respectively including paper feeding rollers 15a and 15b. The paper feeding cassettes 13a and 13b can feed both of unused sheets and reuse sheets.

The printer section 11 includes a charging device 16 configured to uniformly charge a photoconductive drum 14 that rotates in an arrow m direction and a laser exposing device 17 configured to irradiate laser light 17a, which is based on image data or the like output from the scanner section 12, on the charged photoconductive drum 14 and form an electrostatic latent image on the photoconductive drum 14. The printer section 11 includes a developing device 18 configured to supply toner to the electrostatic latent image on the photoconductive drum 14, a transfer device 20 configured to transfer a toner image formed on the photoconductive drum 14 onto a sheet P, which is a recording medium, and a cleaner 21.

The developing device 18 supplies the toner to the electrostatic latent image on the photoconductive drum 14 using a two-component developer, which is a mixture of the toner and a magnetic carrier.

The printer section 11 includes a fixing device 31 between the photoconductive drum 14 and the paper discharging section 22. The MFP 10 includes a conveying path 27, which is a conveying section configured to convey the sheet P from the paper feeding section 13 to the paper discharging section 22 through the photoconductive drum 14 and the fixing device 31. The conveying path 27 includes a registration roller pair configured to convey the sheet P to between the photoconductive drum 14 and the transfer roller 20 in synchronization with the toner image on the photoconductive drum 14 and a paper discharging roller 32 configured to discharge the sheet P to the paper discharging section 22 after fixing.

With the configuration explained above, the MFP 10 transfers the toner image formed by the printer section 11 onto the sheet P fed from the paper feeding section 13. The MFP 10 fixes the toner image on the sheet P with the fixing device 31 and discharges the sheet P to the paper discharging section 22. A print system of the printer section 11 is not limited to an electrophotographic system and may be an inkjet system and the like.

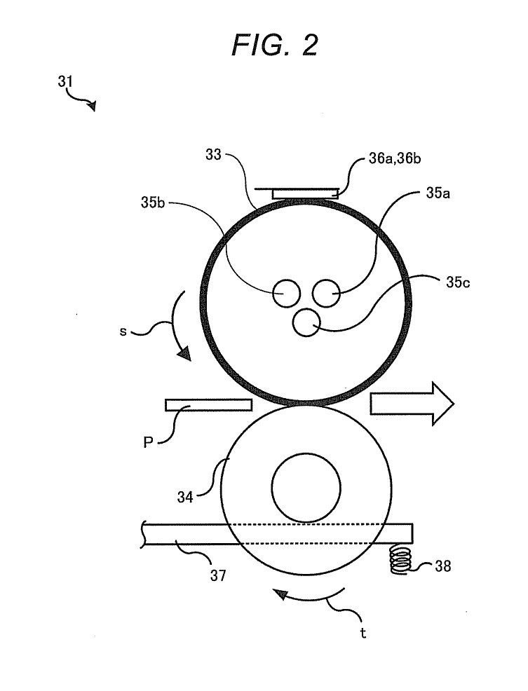

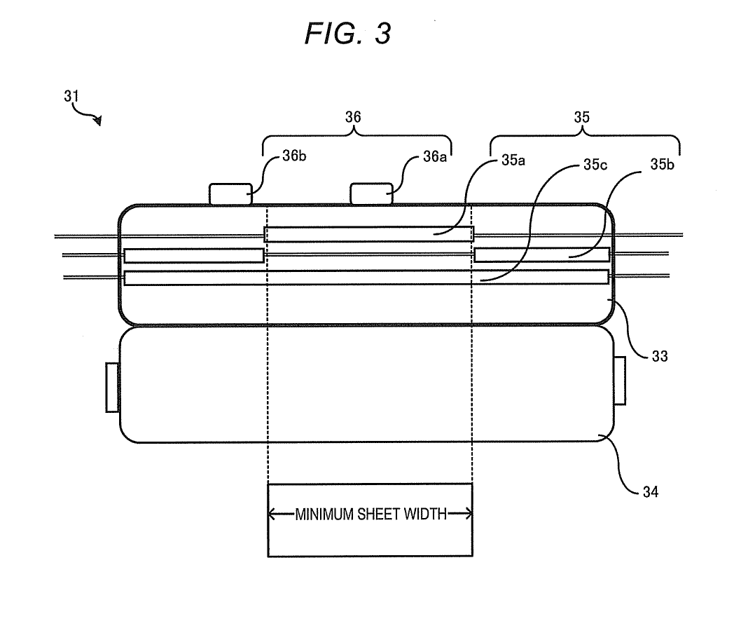

The fixing device 31 is explained. FIG. 2 is a sectional view for explaining the schematic configuration of the fixing device 31. FIG. 3 is a diagram of the fixing device 31 viewed from a sheet conveying direction. The fixing device 31 includes a heat roller 33, which is an image side rotating member, and a press roller 34, which is a non-image side rotating member. The diameter of the heat roller 33 and the press roller 34 is φ35 mm. The heat roller 33 is driven in an arrow s direction by a driving motor (not shown in the figure). The press roller 34 is brought into press contact with the heat roller 33 by a pressurizing spring 38. Consequently, a nip having a fixed width is formed between the heat roller 33 and the press roller 34. The press roller 34 rotates in an arrow t direction following the heat roller 33.

The material of the heat roller 33 is, for example, aluminum (Al) having thickness of 0.8 mm. The surface of a hollow roller of the heat roller 33 is coated with a release layer of Teflon or the like. The heat roller 33 includes three halogen lamps 35 on a hollow inside thereof. A center lamp 35a heats a center area in a rotation axis direction of the heat roller 33. The width of the center lamp 35a is suitably set wider than a minimum sheet width by, for example, about 5%. Side lamps 35b heat side areas located on the left and the right of the center area. An auxiliary lamp 35c heats an entire area in the rotation axis direction (the longitudinal direction) of the heat roller 33. In this embodiment, among the three halogen lamps 35, power consumption of the center lamp 35a and the side lamps 35b is set to 600 W, power consumption of the auxiliary lamp 35c is set to 300 W, and maximum power consumption of the fixing device 31 is set to 900 W. The center lamp 35a and the side lamps 35b function as main heating sources of the heat roller 33. However, since the maximum power consumption is 900 W, the center lamp 35a and the side lamps 35b are not simultaneously lit. The auxiliary lamp 35c is not only lit simultaneously with the center lamp 35a or the side lamps 35b but also lit independently. The auxiliary lamp 35c functions as an auxiliary heating source of the heat roller 33. The halogen lamps 35 have different luminous intensity distributions adjusted to heating positions of the heat roller 33. The halogen lamps 35 are lit and extinguished at predetermined timings by temperature control programs (not shown in the figure) explained below. The heating sources of the heat roller 33 are not limited to a heater lamp system and may be an IH heater system.

In the press roller 34, an elastic layer formed of silicon rubber, fluorocarbon rubber, or the like is formed around a cored bar. Pressure is applied to a roller supporting body 37 of the press roller 34 from the spring 38, whereby the outer circumferential surface of the press roller 34 comes into contact with the outer circumferential surface of the heat roller 33.

Two thermistors 36 are arranged on the outer circumferential surface of the heat roller 33 as temperature detecting members in order to detect a surface temperature of the heat roller 33. A center thermistor 36a detects a surface temperature of the center area located in the center in the rotation axis direction of the heat roller 33. A side thermistor 36b detects surface temperatures of the side areas located on the left and the right of the center area.

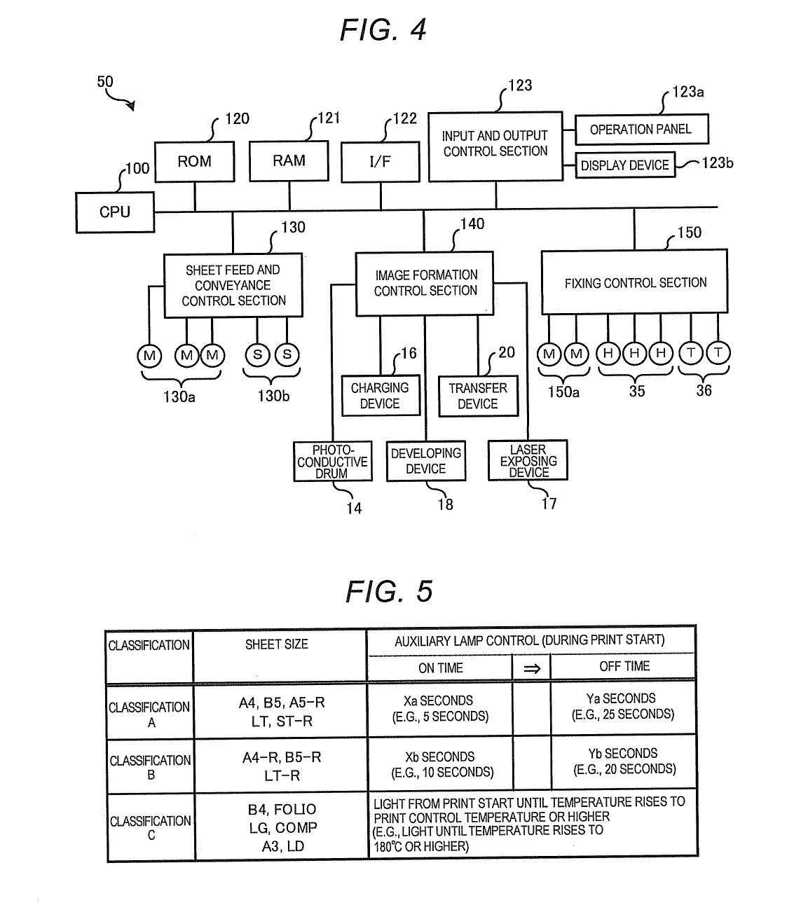

FIG. 4 is a block diagram showing a control system of the MFP 10 in the first embodiment. A control system 50 includes, for example, the CPU 100 configured to control the entire MFP 10, a read only memory (ROM) 120, a random access memory (RAM) 121, an interface (I/F) 122, an input and output control section 123, a paper feed and conveyance control section 130, an image formation control section 140, and a fixing control section 150.

The CPU 100 executes a computer program stored in the ROM 120 or the RAM 121 to thereby realize a processing function for image formation. The ROM 120 stores a control program for managing a basic operation of image formation processing, control data, and the like. The RAM 121 is a working memory. The ROM 120 (or the RAM 121) stores, for example, control data such as a print control temperature (an upper limit value and a lower limit value) and control conditions of the auxiliary lamp 35c together with temperature control programs for the fixing device 31 and the like.

The I/F 122 performs communication with various apparatuses such as a user terminal and a facsimile. The input and output control section 123 controls an operation panel 123a and a display device 123b. The paper feed and conveyance control section 130 controls a motor group 130a and the like configured to drive the paper feeding rollers 15a and 15b of the paper feeding section 13 or conveying rollers 28 of the conveying path 27, the registration roller pair 30, the paper discharging roller 32, and the like. The paper feed and conveyance control section 130 controls the motor group 130a and the like taking into account detection results of various sensors 130b of the paper feeding section 13 or the conveying path 27 on the basis of control signals output from the CPU 100. The image formation control section 140 controls the photoconductive drum 14, the charging device 16, the laser exposing device 17, the developing device 18, the transfer device 20, and the like on the basis of control signals output from the CPU 100.

The fixing control section 150 controls driving motors 150a, the halogen lamps 35, and the thermistors 36 of the fixing device 31 on the basis of control signals output from the CPU 100.

FIG. 5 is a diagram showing an example of auxiliary heating conditions in this embodiment. Sheet sizes are classified into three classifications. An energizing time (an ON time) and a non-energizing time (an OFF time) of the auxiliary lamp 35c during a print start (during an image formation start) are defined for each of sheet size classifications.

Sheet sizes belonging to the sheet size classification A include A4, B5, A5-R, LT, and ST-R. As the auxiliary heating condition in the sheet size classification A, the auxiliary lamp 35c is turned on for Xa seconds (e.g., 5 seconds) from the print start and thereafter turned off for Ya seconds (e.g., 25 seconds).

Sheet sizes belonging to the sheet size classification B include A4-R, B5-R, and LT-R larger than the sheet sizes in the sheet size classification A. As the auxiliary heating condition in the sheet size classification B, the auxiliary lamp 35c is turned on for Xb seconds (e.g., 10 seconds) from the print start and thereafter turned off for Yb seconds (e.g., 20 seconds).

Sheet sizes belonging to the sheet size classification C include B4, FOLIO, LG, COMP, A3, and LD larger than the sheet sizes in the sheet size classification B. In the sheet size classification C, unlike the sheet size classification A and the sheet size classification B, the ON time and the OFF time are not defined. Instead, as the auxiliary heating condition, an ON state is maintained from the print start until the temperature of a sheet rises to a predetermined print control temperature (e.g., 180° C.) or higher. In this embodiment, the sheet size classifications are the three classifications. However, the sheet size classifications only have to be two or more classifications. The number of classifications is not limited to three.

The MFP 10 in this embodiment includes a sheet size determination program and a heating source control program as temperature control programs. The sheet size determination program acquires information concerning a sheet size detected by a sensor (not shown in the figure) mounted in the MFP 10 or information concerning a sheet size selected by a user on the operation panel 123a and outputs the acquired information to the heating source control program. The heating source control program counts an elapsed time from the print start with a time counter (not shown in the figure), acquires, on the basis of the sheet size, an energizing time and a non-energizing time out of the auxiliary heating condition information stored by the ROM 120 or the RAM 121 (an auxiliary-heating-condition storing section), and controls heating in the auxiliary lamp 35c (an auxiliary heating source) on the basis of the energizing time, the non-energizing time, and the elapsed time. In this embodiment, control programs and control data for the fixing device 31 are stored in the ROM 120 (or the RAM 121). However, an arithmetic processing device (not shown in the figure) and a storage device (not shown in the figure) may be incorporated in the fixing device 31 to perform control.

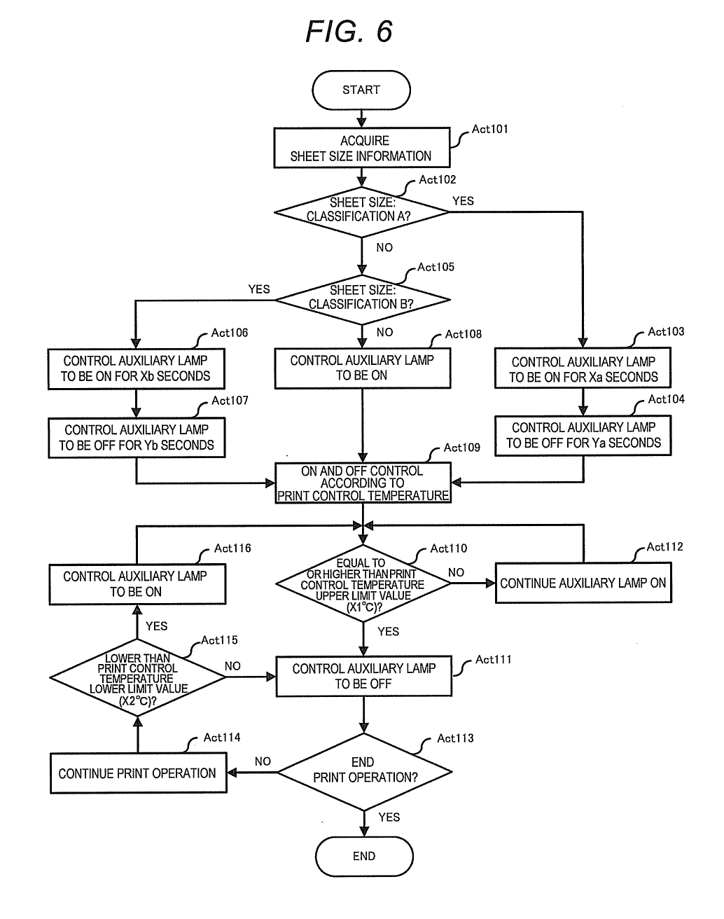

FIG. 6 is a flowchart showing a specific example of heating control in the fixing device 31 in this embodiment. The heating source control program refers to the auxiliary heating conditions shown in FIG. 5.

The sheet size determination program acquires information concerning a sheet size detected by the sensor (not shown in the figure) mounted in the MFP 10 or information concerning a sheet size selected by the user on the operation panel 123a and outputs the acquired information to the heating source control program (Act 101).

The heating source control program refers to the auxiliary heating conditions stored in advance in the ROM 120 (or the RAM 121) on the basis of the sheet size and determines whether the sheet size belongs to the classification A (Act 102). If the sheet size belongs to the classification A (Act 102: YES), the heating source control program controls the auxiliary lamp 35c to be ON for Xa seconds (Act 103) and thereafter controls the auxiliary lamp 35c to be OFF for Ya seconds on the basis of the auxiliary heating conditions and proceeds to Act 109. In the example shown in FIG. 5, in the sheet size classification A, Xa=5(s) and Ya=25(s).

If the sheet size belongs to the classification other than the classification A (Act 102: NO), the heating source control program determines whether the sheet size belongs to the classification B (Act 105). If the sheet size belongs to the classification B (Act 105: YES), the heating source control program controls the auxiliary lamp 35c to be ON for Xb seconds (Act 106) and thereafter controls the auxiliary lamp 35c to be OFF for Yb seconds (Act 107) on the basis of the auxiliary heating conditions and proceeds to Act 109. In the example shown in FIG. 5, in the sheet size classification B, Xb=10(s) and Yb=20(s).

If the sheet size belongs to the classification other than the classifications A and B, that is, belongs to the classification C (Act 105: NO), the heating source control program controls the auxiliary lamp 35c to be ON (Act 108) and proceeds to Act 109. In the example shown in FIG. 5, in the sheet size classification C, the lengths of the ON time and the OFF time of the auxiliary lamp 35c are not defined.

In Act 109, the heating source control program starts ON and OFF control of the auxiliary lamp 35c according to a print control temperature.

Subsequently, the heating source control program determines whether a surface temperature of the heat roller 33 detected by the thermistors 36 is equal to or higher than a print control temperature upper limit value (X1° C.) (Act 110). If the heating source control program determines that the surface temperature is equal to or higher than the print control temperature upper limit value (X1° C.) (Act 110: YES), the heating source control program controls the auxiliary lamp 35c to be OFF (Act 111) and proceeds to Act 113. At this point, the heating source control program also controls the main lamps (the center lamp 35a and the side lamps 35b) to be OFF.

If the heating source control program determines that the surface temperature is lower than the print control temperature upper limit value (X1° C.) (Act 110: NO), the heating source control program continues to control the auxiliary lamp 35c to be in the ON state (Act 112) and returns to Act 110.

In Act 113, the heating source control program determines whether the MFP 10 ends a print operation. If the MFP 10 ends the print operation (Act 113: YES), the heating source control program ends the processing. If the MFP 10 does not end the print operation (Act 113: NO), the heating source control program continues the print operation (Act 114) and proceeds to Act 115.

In Act 115, the heating source control program determines whether the surface temperature of the heat roller 33 detected by the thermistors 36 is lower than a print control temperature lower limit value (X2° C.). If the heating source control program determines that the surface temperature is lower than the print control temperature lower limit value (X2° C.) (Act 115: YES), the heating source control program controls the auxiliary lamp 35c to be ON (Act 116) and proceeds to Act 110. If the heating source control program determines that the surface temperature is equal to or higher than the print control temperature lower limit value (X2° C.) (Act 115: NO), the heating source control program controls the auxiliary lamp 35c to be OFF (Act 111) and proceeds to Act 113 again.

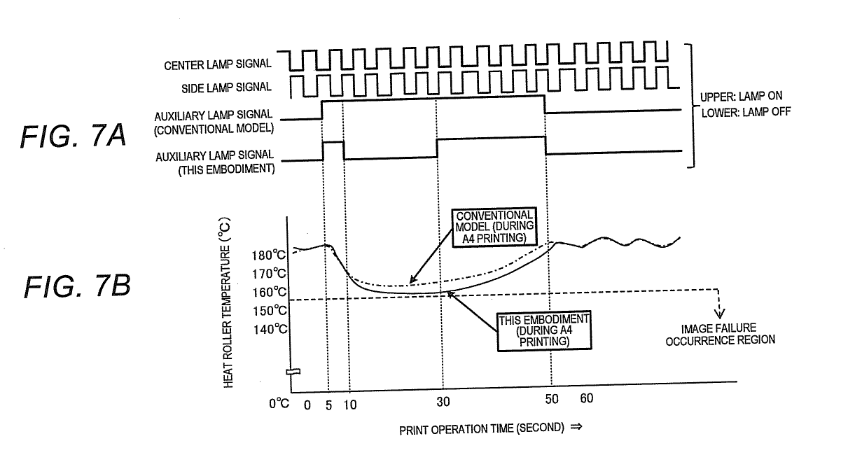

In an upper section (A) of FIG. 7, a relation among a print operation time and switching timings of ON and OFF of the halogen lamps in this embodiment is shown. The center lamp 35a and the side lamps 35b are not simultaneously lit. Switching control of ON and OFF is performed from the start of the print operation. ON and OFF of the auxiliary lamp 35c are switched independently from the main lamps (the center lamp 35a and the side lamps 35b). In an example shown in the upper section (A), the operations of the center lamp 35a and the side lamps 35b are common to both of the conventional model and this embodiment. However, the control of the auxiliary lamp 35c is different. That is, the auxiliary lamp 35c of the conventional model is controlled to be ON after 5 seconds from the start of the print operation and to be OFF after being ON for 45 seconds. On the other hand, the auxiliary lamp 35c in this embodiment is first controlled to be ON after 5 seconds from the start of the print operation and to be OFF after being ON for 5 seconds. This heating indicates that the press roller 34 is heated before a sheet is heated. Subsequently, the auxiliary lamp 35c is controlled to be ON again after 30 seconds from the start of the print operation and to be OFF after being ON for 20 seconds.

In a lower section (B), a relation between the print operation time and a temperature change of the heat roller 33 at the time when the ON and OFF switching shown in the upper section (A) is performed is shown. Temperature changes in the fixing device of the conventional model and the fixing device 31 in this embodiment in the case of the sheet size A4 are shown. A curved line of an alternate long and short dash line in the lower section (B) indicates a temperature change in the conventional model. The auxiliary lamp 35c is controlled to be ON from 5 seconds to 50 seconds after the start of the print operation. The surface temperature changes at temperature about 10° C. or more higher than a boundary value (155° C.) with an image failure occurrence region. That is, excess heating is applied to the sheet.

On the other hand, a curved line of a solid line in the lower section (B) indicates a temperature change in this embodiment. The auxiliary lamp 35c is controlled to be OFF in a period of time of 10 seconds to 30 seconds after the start of the print operation. Therefore, while suppressing power consumption, control in a temperature region where an image failure does not occur is enabled taking into account a sheet size.

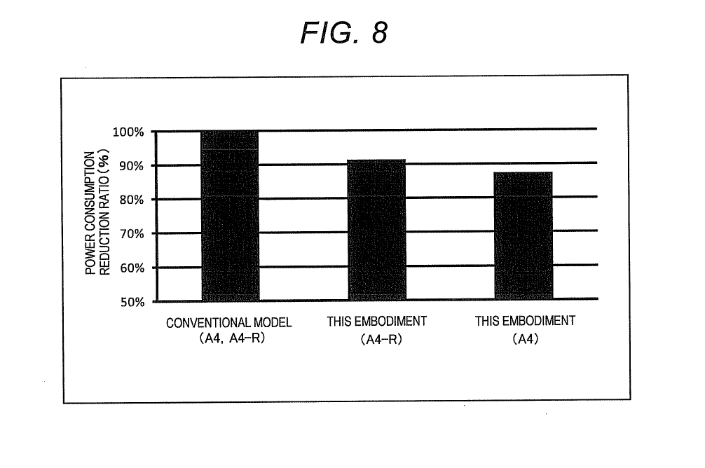

FIG. 8 is a diagram for comparing and explaining power consumptions of the fixing device of the conventional model and the fixing device 31 in this embodiment. The power consumption of the fixing device of the conventional model is fixed irrespective of a sheet size. The figure indicates that, if the power consumption of the fixing device of the conventional mode is assumed to be 100%, the power consumption of the fixing device 31 in this embodiment can be reduced to about 90% during A4-R sheet printing and to about 87% during A4 sheet printing. Since an energizing time and an extinction time of the auxiliary lamp 35c change according to the sheet size, a reduction effect of the power consumption also varies.

As explained above, in the image forming apparatus according to this embodiment, besides the main heating sources (the center lamp 35a and the side lamps 35b) configured to selectively heat a target area, the auxiliary heating source (the auxiliary lamp 35c) configured to auxiliarly heat all areas is provided in the heat roller 33 of the fixing device 31. The main heating sources and the auxiliary heating source are respectively controlled on the basis of the two kinds of heating conditions. Therefore, it is possible to suppress a temperature drop (an undershoot phenomenon) during the print start and prevent occurrence of an image failure.

If the ON and OFF control of the auxiliary lamp 35c is only the control based on the print control temperature as in the related art, the OFF time sometimes cannot be secured sufficiently depending on a print history or an environment. However, in this embodiment, before the heating control based on the print control temperature is executed, the ON and OFF control of the auxiliary lamp 35c based on the auxiliary heating conditions is forcibly executed. Therefore, not only the ON time but also the OFF time can be surely secured and an effect of energy saving is attained.

Further, focusing on a tendency that a temperature drop amount during the print start is larger as the sheet size is larger, the energizing time and the non-energizing time of the auxiliary lamp 35c during the print start are changed according to the size of a fixing target sheet. Therefore, there is an effect that it is possible to reduce power consumption while enabling stable heating under a temperature condition in which an image failure does not occur.

As a basic configuration, first, the image forming apparatus according to this embodiment performs the heating control of the auxiliary lamp 35c based on the energizing time and the non-energizing time (hereinafter referred to as first heating control) and thereafter performs the heating control based on the printer control temperature (hereinafter referred to as second heating control). However, the heating source control program of the image forming apparatus may be configured to always monitor detection information in the center thermistor 36a and the side thermistor 36b and perform the first heating control and the second heating control in parallel. In this case, if the surface temperature of the heat roller 33 exceeds a predetermined printer control temperature upper limit value during heating based on the energizing time, it is possible to perform control for stopping the heating by each of the center lamp 35a (the main heating source), the side lamps 35b (the main heating sources), and the auxiliary lamp 35c (the auxiliary heating source). That is, it is possible to suppress unnecessary heating and further reduce the power consumption of the auxiliary lamp 35c.

### Second Embodiment

An image forming apparatus according to a second embodiment is explained. Reference numerals and signs same as the reference numerals and signs in the first embodiment represent the same components. Therefore, explanation of the components is omitted. Differences from the first embodiment are explained below in detail.

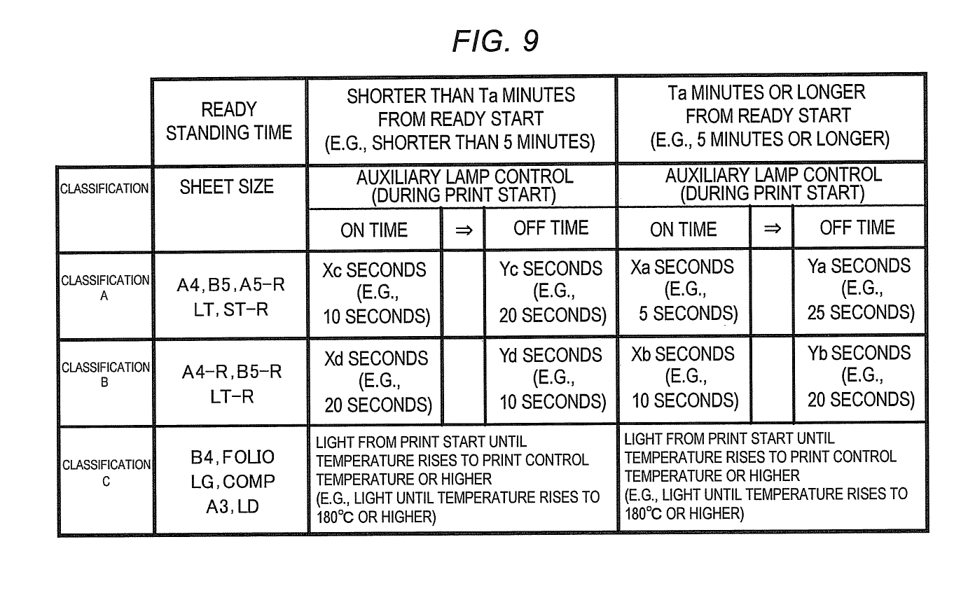

This embodiment is different from the first embodiment in auxiliary heating conditions in the fixing device 31. In the ROM 120 (or the RAM 121), which is the auxiliary-heating-condition storing section, a correspondence relation among a sheet size, an energizing time, a non-energizing time, and a ready standing time of the MFP 10 (or the fixing device 31) is stored as auxiliary heating condition information for each of sheet size classifications. FIG. 9 is a diagram showing an example of the auxiliary heating conditions in this embodiment. The auxiliary heating conditions are roughly classified into two according to the lengths of the ready standing time.

[1] The ready standing time is equal to or longer than Ta minutes (e.g., 5 minutes)

Sheet sizes belonging to the sheet size classification A include A4, B5, A5-R, LT, and ST-R. As the auxiliary heating condition in the sheet size classification A, the auxiliary lamp 35c is turned on for Xa seconds (e.g., 5 seconds) from the print start and thereafter turned off for Ya seconds (e.g., 25 seconds).

Sheet sizes belonging to the sheet size classification B include A4-R, B5-R, and LT-R larger than the sheet sizes in the sheet size classification A. As the auxiliary heating condition in the sheet size classification B, the auxiliary lamp 35c is turned on for Xb seconds (e.g., 10 seconds) from the print start and thereafter turned off for Yb seconds (e.g., 20 seconds).

Sheet sizes belonging to the sheet size classification C include B4, FOLIO, LG, COMP, A3, and LD larger than the sheet sizes in the sheet size classification B. In the sheet size classification C, unlike the sheet size classification A and the sheet size classification B, the ON time and the OFF time are not defined. Instead, as the auxiliary heating condition, an ON state is maintained from the print start until the temperature of a sheet rises to a predetermined print control temperature (e.g., 180° C.) or higher.

[2] The ready standing time is shorter than Ta minutes (e.g., 5 minutes)

As the auxiliary heating condition in the sheet size classification A, the auxiliary lamp 35c is turned on for Xc seconds (e.g., 10 seconds) from the print start and thereafter turned off for Yc seconds (e.g., 20 seconds).

As the auxiliary heating condition in the sheet size classification B, the auxiliary lamp 35c is turned on for Xd seconds (e.g., 20 seconds) from the print start and thereafter turned off for Yd seconds (e.g., 10 seconds).

In the sheet size classification C, unlike the sheet size classification A and the sheet size classification B, the ON time and the OFF time are not defined. Instead, as the auxiliary heating condition, an ON state is maintained from the print start until the temperature of a sheet rises to the predetermined print control temperature (e.g., 180° C.) or higher.

As explained above, the auxiliary heating conditions are set in the auxiliary-heating-condition storing section (the ROM 120 or the RAM 121). Consequently, a heating source control program in this embodiment counts an elapsed time from a start of a print operation and a ready standing time with a time counter (not shown in the figure), acquires, on the basis of the sheet size and the ready standing time, an energizing time from the auxiliary-heating-condition storing section, and controls heating in the auxiliary lamp 35c on the basis of the energizing time and the elapsed time.

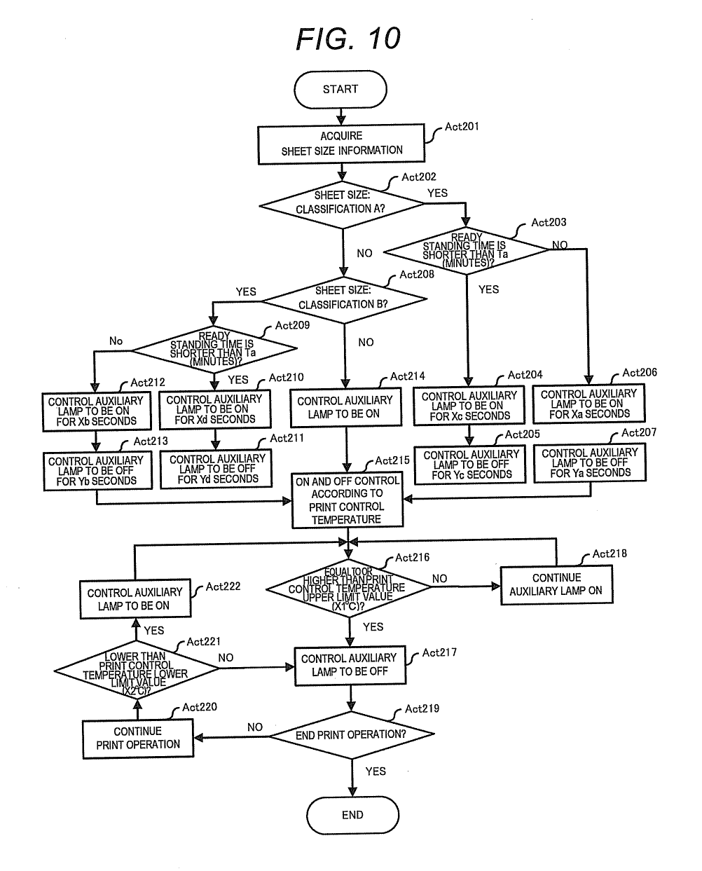

FIG. 10 is a flowchart showing a specific example of heating control in the fixing device 31 in this embodiment. A heating source control program refers to the auxiliary heating conditions shown in FIG. 9.

The sheet size determination program acquires information concerning a sheet size detected by a sensor (not shown in the figure) mounted in the MFP 10 or information concerning a sheet size selected by the user on the operation panel 123a and outputs the acquired information to the heating source control program (Act 201).

The heating source control program refers to the auxiliary heating conditions stored in advance in the auxiliary-heating-condition storing section on the basis of the sheet size and determines whether the sheet size belongs to the classification A (Act 202). If the sheet size belongs to the classification A (Act 202: YES), the heating source control program determines whether the ready standing time is shorter than Ta minutes (Act 203). If the ready standing time is shorter than Ta minutes (Act 203: YES), the heating source control program controls the auxiliary lamp 35c to be ON for Xc seconds (Act 204), thereafter controls the auxiliary lamp 35c to be OFF for Yc seconds (Act 205), and proceeds to Act 215. In the example shown in FIG. 9, if the ready standing time is shorter than Ta minutes and the sheet size belongs to the classification A, Xc=10(s) and Yc=20(s).

If the ready standing time is equal to or longer than Ta minutes (Act 203: NO), the heating source control program controls the auxiliary lamp 35c to be ON for Xa seconds (Act 206) and thereafter controls the auxiliary lamp 35c to be OFF for Ya seconds (Act 207) on the basis of the auxiliary heating conditions and proceeds to Act 215. In the example shown in FIG. 9, if the ready standing time is equal to or longer than Ta minutes and the sheet size belongs to the classification A, Xa=5(s) and Ya=25(s).

If the sheet size belongs to the classification other than the classification A (Act 202: NO), the heating source control program determines whether the sheet size belongs to the classification B (Act 208). If the sheet size belongs to the classification B (Act 208: YES), the heating source control program determines whether the ready standing time is shorter than Ta minutes (Act 209). If the ready standing time is shorter than Ta minutes (Act 209: YES), the heating source control program controls the auxiliary lamp 35c to be ON for Xd seconds (Act 210), thereafter controls the auxiliary lamp 35c to be OFF for Yd seconds (Act 211), and proceeds to Act 215. In the example shown in FIG. 9, if the ready standing time is shorter than Ta minutes and the sheet size belongs to the classification B, Xd=20(s) and Yd=10(s).

If the ready standing time is equal to or longer than Ta minutes (Act 209: NO), the heating source control program controls the auxiliary lamp 35c to be ON for Xb seconds (Act 212) and thereafter controls the auxiliary lamp 35c to be OFF for Yb seconds (Act 213) on the basis of the auxiliary heating conditions and proceeds to Act 215. In the example shown in FIG. 9, if the ready standing time is equal to or longer than Ta minutes and the sheet size belongs to the classification B, Xb=10(s) and Yb=20(s).

If the sheet size belongs to the classification other than the classifications A and B, that is, belongs to the classification C (Act 208: NO), the heating source control program controls the auxiliary lamp 35c to be ON (Act 214) and proceeds to Act 215. In the example shown in FIG. 9, in the sheet size classification C, the lengths of the ON time and the OFF time of the auxiliary lamp 35c are not defined.

In Act 215, the heating source control program starts ON and OFF control of the auxiliary lamp 35c according to a print control temperature.

Subsequently, the heating source control program determines whether a surface temperature of the heat roller 33 detected by the thermistors 36 is equal to or higher than a print control temperature upper limit value (X1° C.) (Act 216). If the heating source control program determines that the surface temperature is equal to or higher than the print control temperature upper limit value (X1° C.) (Act 216: YES), the heating source control program controls the auxiliary lamp 35c to be OFF (Act 217) and proceeds to Act 219. At this point, the heating source control program also controls the main lamps (the center lamp 35a and the side lamps 35b) to be OFF.

If the heating source control program determines that the surface temperature is lower than the print control temperature upper limit value (X1° C.) (Act 216: NO), the heating source control program continues to control the auxiliary lamp 35c to be in the ON state (Act 218) and returns to Act 216.

In Act 219, the heating source control program determines whether the MFP 10 ends a print operation. If the MFP 10 ends the print operation (Act 219: YES), the heating source control program ends the processing. If the MFP 10 does not end the print operation (Act 219: NO), the heating source control program continues the print operation (Act 220) and proceeds to Act 221.

In Act 221, the heating source control program determines whether the surface temperature of the heat roller 33 detected by the thermistors 36 is lower than a print control temperature lower limit value (X2° C.). If the heating source control program determines that the surface temperature is lower than the print control temperature lower limit value (X2° C.) (Act 221: YES), the heating source control program controls the auxiliary lamp 35c to be ON (Act 222) and proceeds to Act 216. If the heating source control program determines that the surface temperature is equal to or higher than the print control temperature lower limit value (X2° C.) (Act 221: NO), the heating source control program controls the auxiliary lamp 35c to be OFF (Act 217) and proceeds to Act 219 again.

As explained above, with the image forming apparatus according to this embodiment, the auxiliary heating conditions are roughly classified into two according to the lengths of the ready standing time and the heating control in the fixing device 31 is executed. If the ready standing time is short, the surface temperature of the heat roller 33 is maintained in a state in which the surface temperature is sufficiently higher than temperature at which an image failure occurs. Therefore, it is possible to reduce the energizing time (the ON time) of the auxiliary lamp 35c. Consequently, in addition to the effect of the first embodiment, there is an effect that it is possible to further reduce the power consumption if the ready standing time is short.

While certain embodiments have been described, these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

1. An image forming apparatus comprising:
a heating member configured to heat a medium carrying a toner image having a first area which the medium of a predetermined size passes through and a second area which is positioned outside of the first area in a longitudinal direction;
a pressurizing member arranged to be opposed to the heating member and configured to convey the medium while holding the medium in conjunction with the heating member;
a main heating source provided inside the heating member having two portions individually corresponding to the first area and the second area respectively;
an auxiliary heating source provided on an inside of the heating member and configured to simultaneously heat the first area and the second area;
detecting members configured to respectively detect surface temperatures of the first area and the second area;
an auxiliary-heating-condition storing section configured to store an energizing time and a non-energizing time of the auxiliary heating source at the start of the image formation corresponding to the medium size; and
heating-source control sections configured to control the heating in the main heating source while selecting either the first area or the second area so as to switch a target area of heating and configured to control the heating in the auxiliary heating source independently from the main heating source, wherein
the heating-source control sections acquire the energizing time and the non-energizing time from the auxiliary-heating-condition storing section based on the medium size and control the heating in the auxiliary heating source.

2. (canceled)

3. The apparatus according to claim 1, wherein the heating-source control section counts an elapsed time from the start of the image formation, acquires the energizing time and the non-energizing time from the auxiliary-heating-condition storing section on the basis of the medium size, and controls the heating in the auxiliary heating source on the basis of the energizing time, the non-energizing time, and the elapsed time.

4. (canceled)

5. The apparatus according to claim 1, wherein the auxiliary-heating-condition storing section stores the energizing time and the non-energizing time of the auxiliary heating source at the start of the image formation corresponding to a ready standing time when the image forming apparatus is being maintained in a ready state up to the start of the image formation.

6. The apparatus according to claim 5, wherein the heating-source control section counts an elapsed time from the start of the image formation and the standing time, acquires the energizing time and the non-energizing time from the auxiliary-heating-condition storing section on the basis of the medium size and the ready standing time, and controls the heating in the auxiliary heating source on the basis of the energizing time, the non-energizing time, and the elapsed time.

7. The apparatus according to claim 6, wherein the auxiliary-heating-condition storing section classifies the medium size into two or more medium size classifications and stores a corresponding relation among the medium size classifications, the energizing time, and the non-energizing time.

8. The apparatus according to claim 7, wherein, if the surface temperature exceeds a predetermined printer control temperature upper limit value during heating based on the energizing time, the heating-source control sections respectively stop the heating by the main heating source and the heating by the auxiliary heating source.

9. A temperature control method for a fixing device in an image forming apparatus, comprising:
storing, as auxiliary heating condition information, in a storage device, a correspondence relation between a medium size of a medium carrying a toner image, an energizing time of an auxiliary heating source incorporated in a heating member of the fixing device, and a non-energizing time of the auxiliary heating source;
determining the medium size;
acquiring the energizing time and the non-energizing time of the auxiliary heating source out of the auxiliary heating condition information in the storage device based on the medium size;
simultaneously heating a first area which the medium of a predetermined size passes through and a second area which is positioned outside of the first area in the longitudinal direction of the heating member with the auxiliary heating source on the basis of the energizing time and the non-energizing time having been acquired;
switching and heating the first area and the second area of the heating member with a main heating source incorporated in the heating member of the fixing device;
respectively detecting surface temperatures of the first area and the second area with detecting members;
controlling the heating in the main heating source while selecting either the first area or the second area so as to switch a target area of heating; and
controlling the heating in the auxiliary heating source for simultaneously heating the first area and the second area independently from the main heating source.

10. A temperature control method for a fixing device in an image forming apparatus, comprising:
storing, as auxiliary heating condition information, in a storage device, a correspondence relation between a medium size of a medium carrying a toner image, an energizing time of an auxiliary heating source incorporated in a heating member of the fixing device, a non-energizing time of the auxiliary heating source, and a ready standing time when the image forming apparatus is being maintained in a ready state up to the start of the image formation;
determining the medium size;
counting the ready standing time;
acquiring the energizing time and the non-energizing time of the auxiliary heating source out of the auxiliary heating condition information in the storage device based on the medium size and the ready standing time;
simultaneously heating a first area which the medium of a predetermined size passes through and a second area which is positioned outside of the first area in the longitudinal direction of the heating member with the auxiliary heating source on the basis of the energizing time and the non-energizing time having been acquired;
switching and heating the first area and the second area of the heating member with a main heating source incorporated in the heating member of the fixing device;
controlling the heating in the main heating source while selecting either the first area or the second area so as to switch a target area of heating; and
controlling the heating in the auxiliary heating source for simultaneously heating the first area and the second area independently from the main heating source.
